(19) United States
(12) Patent Application Publication
(10) Pub. No.: US 2025/0004506 A1
(43) Pub. Date: Jan. 2, 2025

(54) ELECTRONIC DEVICE

(71) Applicant: Lenovo (Beijing) Limited, Beijing (CN)

(72) Inventors: Lin XU, Beijing (CN); Zhiliang LV, Beijing (CN); Xiaoxiao WU, Beijing (CN)

(21) Appl. No.: 18/671,098

(22) Filed: May 22, 2024

(30) Foreign Application Priority Data
Jun. 27, 2023 (CN) 202310770225.4

(51) Int. Cl. G06F 1/16; E05D 11/06; E05D 11/08; F16C 11/04

(52) U.S. Cl. CPC G06F 1/1681; F16C 11/04; E05D 11/06; E05D 11/082; E05Y 2201/224; E05Y 2201/266

(57) ABSTRACT

An electronic device includes a first body, a second body, and a linkage control assembly. The linkage control assembly includes a rotation shaft, a position-limiting linkage member, and a position-limiting mating member. The rotation shaft is configured to rotatably connect the first body and the second body. The position-limiting linkage member is arranged at the rotation shaft. The position-limiting mating member is arranged at a side of the rotation shaft close to the first body. The position-limiting linkage member is configured to cooperate with the position-limiting mating member to perform position-limiting on the rotation angle of the second body. The position-limiting linkage member rotates based on an extension length and/or a weight increase value along a first direction. The position-limiting linkage member rotates along a second direction based on the retraction length of the second body and/or a weight decrease value.

### CROSS-REFERENCE TO RELATED APPLICATION

The present disclosure claims priority to Chinese Patent Application No. 202310770225.4, filed on Jun. 27, 2023, the entire content of which is incorporated herein by reference.

### TECHNICAL FIELD

The present disclosure is related to the electronic device technology field and, more particularly, to an electronic device.

### BACKGROUND

In an electronic device such as a laptop that requires opening and closing, a rotation shaft damping is arranged at an opening and closing rotation shaft of the electronic device. The electronic device has a maximal opening and closing angle with the rotation shaft damping and the weight of the electronic device.

Some existing laptops are provided with scroll screens. When a scroll screen is extended and retracted, the weights of the scroll screen and a keyboard are dynamically changed. To ensure easy operation of the user opening and closing the scroll screen, the rotation shaft damping is of a relatively stable value. Thus, to ensure the stability of the laptop on a table after being opened, the maximal value position of unfolding the scroll screen needs to be restricted to ensure the laptop is still stably placed when the scroll screen is unfolded maximally. However, such a restriction impairs the user experience of screen preview during the use of the laptop.

Therefore, it is desired to improve the user screen preview experience for the electronic device with the scroll screen.

### SUMMARY

An aspect of the present disclosure provides an electronic device, including a first body, a second body, and a linkage control assembly. The linkage control assembly includes a rotation shaft, a position-limiting linkage member, and a position-limiting mating member. The rotation shaft is configured to rotatably connect the first body and the second body. The position-limiting linkage member is arranged at the rotation shaft. The position-limiting mating member is arranged at a side of the rotation shaft close to the first body. The position-limiting linkage member is configured to cooperate with the position-limiting mating member to perform position-limiting on the rotation angle of the second body. The position-limiting linkage member rotates based on an extension length and/or a weight increase value along a first direction. The position-limiting linkage member rotates along a second direction based on the retraction length of the second body and/or a weight decrease value. The first direction and the second direction are opposite directions.

### BRIEF DESCRIPTION OF THE DRAWINGS

FIG. 1 illustrates a schematic structural diagram of a linkage control assembly of an electronic device according to some embodiments of the present disclosure.

FIG. 2 illustrates a schematic structural diagram of a position-limiting structure and a positioning structure according to some embodiments of the present disclosure.

FIG. 3 illustrates a schematic diagram showing linkage rotation of a position-limiting linkage member when rotating along a first direction based on an extension of a second body according to some embodiments of the present disclosure.

FIG. 4 illustrates a schematic structural diagram of a position-limiting linkage member when a second body is at a first retractable length according to some embodiments of the present disclosure.

FIG. 5 illustrates a schematic structural diagram of a position-limiting linkage member when a second body is at a second retractable length according to some embodiments of the present disclosure.

FIG. 6 illustrates a schematic structural diagram of a position-limiting linkage member when a second body is at a third retractable length according to some embodiments of the present disclosure.

FIG. 7 illustrates a schematic structural diagram of a linkage member according to some embodiments of the present disclosure.

FIG. 8 illustrates a schematic structural diagram of another linkage member according to some embodiments of the present disclosure.

FIG. 9 illustrates a schematic diagram showing a vertical projection of a first body and a second body on a carrier surface according to some embodiments of the present disclosure.

FIG. 10 illustrates a schematic structural diagram showing a second body being at a predetermined closed angle range according to some embodiments of the present disclosure.

FIG. 11 illustrates a schematic structural diagram showing front of a first damping assembly according to some embodiments of the present disclosure.

FIG. 12 illustrates a schematic structural diagram showing a side of a first damping assembly according to some embodiments of the present disclosure.

### REFERENCE NUMERALS

| | | |
|---|---|---|
| 100 First body | 200 Second body | 300 Linkage |
| | | control assembly |
| 301 Position-limiting | 3011 Position-limiting | |
| linkage member | structure | |
| 302 Position-limiting | 3021 Positioning structure | |
| mating member | | |
| 303 Linkage member | 400 First damping assembly | |
| 401 Damping | 402 Elastic damping | |
| adjustment member | member | |

### DETAILED DESCRIPTION OF THE EMBODIMENTS

The present disclosure provides an electronic device to improve the user experience for a screen preview of the electronic device with a scroll screen.

The technical solutions of embodiments of the present disclosure are described in detail in connection with the accompanying drawings of embodiments of the present disclosure. Apparently, described embodiments are merely some embodiments of the present disclosure, not all embodiments. Based on embodiments of the present disclosure, all other embodiments obtained by those skilled in the art without creative efforts are within the scope of the present disclosure.

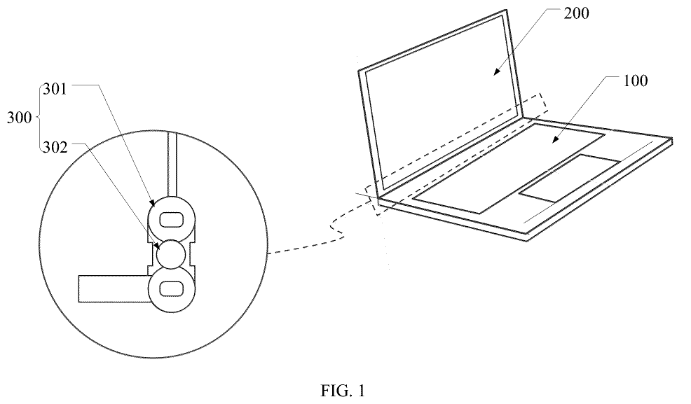

As shown in FIGS. 1 to 12, embodiments of the present disclosure provide an electronic device. The electronic device includes a first body 100, a second body 200, and a linkage control assembly 300. The first body 100 can be configured to cause the electronic device to be placed on a carrier surface. The second body 200 can be retractable.

The linkage control assembly 300 includes a rotation shaft, a position-limiting linkage member 301, and a position-limiting mating member 302. The rotation shaft is rotatably connected between the first body 100 and the second body 200. The position-limiting linkage member 301 is arranged at the rotation shaft. The position-limiting mating member 302 is arranged at one side of the rotation shaft close to the first body 100. The position-limiting linkage member 301 can be configured to cooperate with the position-limiting mating member 302 to limit the position of the rotation angle of the second body 200 to limit the rotation angle of the second body 200 relative to the first body 100. That is, the opening angle of the electronic device can be limited to cause the electronic device to remain stable when the electronic device is in an opening state.

The electronic device can be a scroll-screen laptop, a scroll-screen phone, a retractable screen tablet, etc. The first body 100 and the second body 200 can be two parts of the electronic device with relative rotation requirements. The first body 100 and the second body 200 can be rotatably connected via the rotation shaft to realize the relative rotation. The second body 200 can be retractable. For example, the second body 200 can be a display screen that is retractable, such as the scroll screen or the retractable screen. The first body 100 can be a keyboard or a supporting bracket. Based on the retractable change of the second body 200, the length and/or weight of the second body 200 can be dynamically changed. The damping of the existing electronic device can be fixed. Thus, to place the electronic device stably on a surface, the rotation angle of the second body 200 can be limited according to the length change and/or weight change of the second body 200 to cause the electronic device to be stably placed on the surface in the opening state.

In some embodiments, the position-limiting linkage member 301 can rotate along the first direction based on the extension length and/or weight increase of the second body 200. Thus, the position-limiting structure 3011 of the position-limiting linkage member 301 that is configured to cooperate with the position-limiting mating member 302 can rotate along the first direction. Thus, when the position-limiting linkage member 301 and the position-limiting mating member 302 are in a position-limiting mating state, the opening angle of the electronic device can be reduced. That is, the maximal rotation angle of the second body 200 can be reduced. The position-limiting linkage member 301 can rotate along the second direction based on the retracted length and/or reduced weight value of the second body 200. The first direction and the second direction can be opposite directions. Thus, the position-limiting structure 3011 of the position-limiting linage member 301 that is configured to position-limiting cooperate with the position-limiting mating member 302 can rotate along a reverse direction of the first direction. Thus, when the position-limiting linkage member 301 and the position-limiting mating member 302 are in the position-limiting cooperation state, the opening angle of the electronic device can be increased. That is, the maximal rotation angle of the second body 200 can be increased. Thus, the rotation angle of the second body 200 can adapt to the retractable length and/or weight change of the second body 200.

In the electronic device of the present disclosure, the position-limiting linkage member 301 can rotate based on the retractable change and/or the weight change of the second boy 200 to cause the position-limiting angle of the position-limiting linkage member 301 and the position-limiting mating member 302 to be dynamically adjusted. Thus, the maximal rotation angle of the second body 200 can be dynamically adjusted. When the second body 200 is extended and retracted to a maximal value, the electronic device can be still placed stably. In embodiments of the present disclosure, the electronic device can be a laptop, the second body 200 can be the scroll screen. By dynamically adjusting the maximal rotation angle of the scroll screen, the unfolded length of the scroll screen can be extended. Thus, the user experience for the screen preview of the scroll screen of the electronic device.

The position-limiting linkage member 301 can rotate based on the retraction change and/or the weight change of the second body 200 in a mechanical transmission or electromechanical control method, as long as the setting method can satisfy the application requirement within the scope of the present disclosure.

In some embodiments, the linkage control assembly 300 can further include a linkage member 303. Thus, the retractable movement of the second body 200 can be transferred to the position-limiting linkage member 301 in the mechanical transmission method. An end of the linkage member 303 can be arranged at the retractable end of the second body 200. The other end can cooperate or be connected to the position-limiting member 301 to transfer the retractable movement of the second body 200 to the position-limiting linkage member 301 through the mechanical transmission method. Thus, the position-limiting linkage member 301 can move together with the retractable movement of the second body 200 in the mechanical transmission method.

The linkage member 303 can be a chain, a linkage rod, a belt, or a gear. As long as the component can transfer the retractable movement of the second body 200 to the position-limiting linkage member 301 through the mechanical transmission method, the component can be within the scope of the present disclosure.

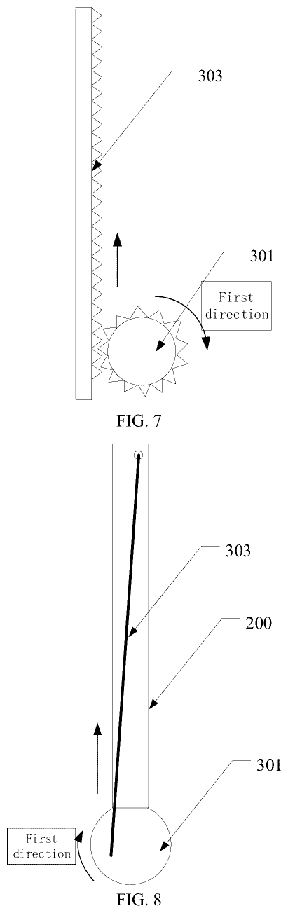

As shown in FIG. 7, in some embodiments of the present disclosure, the linkage member 303 includes a gear member. The gear member is arranged at the retractable end of the second body 200. A transmission gear is arranged at an outer circumference of the position-limiting linkage member 301. The transmission gear can mesh with the gear member to cause the gear member to move along the extension direction of the second body 200 with the extension of the second body 200. As the gear member moves along the extension direction of the second body 200, the gear member can drive the transmission gear meshed with the gear member to rotate along the first direction. Thus, when the position-limiting linkage member 301 and the position-limiting mating member 302 are in the position-limiting cooperation state, the rotation angle of the second body 200 can be reduced. Thus, the electronic device can be placed stably on the carrier surface. The gear member can move along the retraction direction of the second body 200 with the retraction of the second body 200. The gear member can move along the retraction direction of the second body 200, and the gear member can drive the transmission gear meshed with the gear member to rotate along the second direction. Thus, when the position-limiting linkage member 301 and the position-limiting mating member 302 are within the position-limiting cooperation state, the rotation angle of the second body 200 can be increased, and the rotation angle of the second body 200 can be expanded.

The gear member can be a rack or a toothed belt. As long as the component cooperates with the transmission gear of the position-limiting linkage member 301, the component can be within the scope of the present disclosure.

As shown in FIG. 8, in some other embodiments of the present disclosure, the linkage transmission member 303 includes a linkage rod. Two ends of the linkage rod are rotatably connected to the retractable end of the second body 200 and the position-limiting linkage member 301, respectively. Thus, the linkage rod can move along the extension direction of the second body 200 as the second body 200 extends. With the linkage rod moving, the linkage rod can pull the position-limiting linkage member 301 connected to the linkage rod to rotate along the first direction to cause the position-limiting member 301 to rotate along the first direction with the extension of the second body 200. Thus, when the position-limiting linkage member 301 and the position-limiting mating member 302 are in the position-limiting cooperation state, the rotation angle of the second body 200 can be reduced to place the electronic device stably on the carrier surface. Thus, the linkage rod can move along the retraction direction of the second body 200 as the second body 200 retracts. With the movement of the linkage rod, the linkage rod can push the position-limiting linkage member 301 connected to the linkage rod can rotate along the second direction. The position-limiting linkage member 301 can rotate along the second direction as the second body 200 retracts. Thus, when the position-limiting linkage rod 301 and the position-limiting mating member 302 are in the position-limiting cooperation state, the rotation angle of the second body 200 can be increased, and the rotation angle of the second body 200 can be expanded.

In addition, in other embodiments of the present disclosure, the linkage control assembly 300 can cause the position-limiting linkage member 301 to rotate based on the retractable change and/or the weight change of the second body 200 in the electromechanical control method. The linkage response speed can be fast, and the sensitivity can be high.

In some embodiments, the linkage control assembly 300 can further include a telescopic length sensor, a position-limiting linkage controller, and a linkage rotation driver. The telescopic length sensor can be configured to sense the telescopic length of the second body 200. The position-limiting linkage controller and the telescopic length sensor can transmit the signals to each other. The linkage rotation driver can be configured to control the position-limiting linkage member 301 to rotate, and the linkage rotation driver and the position-limiting linkage controller can transmit the signals to each other. Thus, the telescopic length sensor can sense the telescopic length of the second body 200. The telescopic length of the second body 200 can be transmitted to the position-limiting linkage controller with an electrical signal. By limiting the linkage controller to control the linkage rotation driver to operate, the linkage rotation driver can drive the position-limiting linkage member 301 to rotate. Thus, the position-limiting linkage member 301 can rotate based on the telescopic of the second body 200.

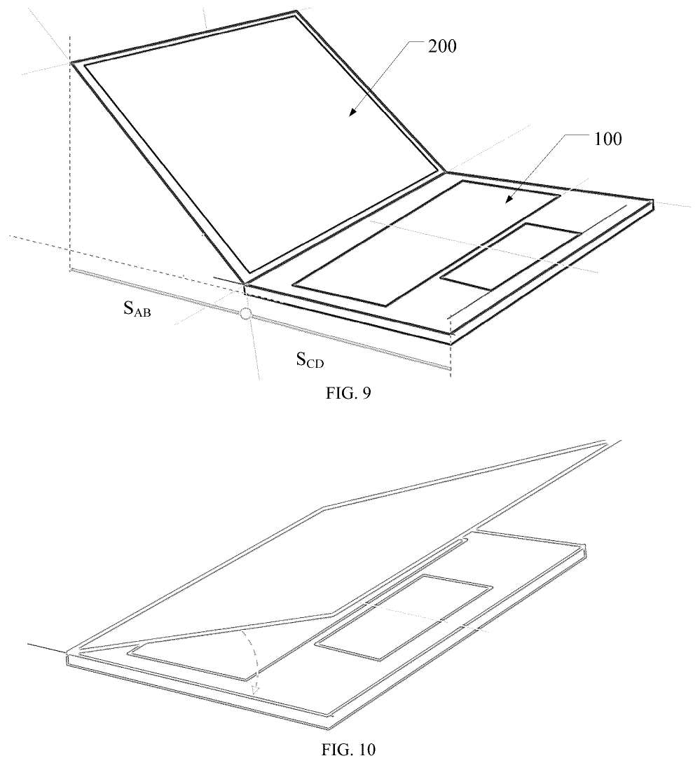

The above position-limiting linkage controller can pre-receive and store the calculation logic of the maximal rotation angle of the second body 200. As shown in FIG. 9, when a vertical projection length of the second body 200 on the carrier surface is S_{AB}, and the vertical projection length of the first body 100 on the carrier surface is S_{CD}. The weight of the second body 200 can be F_{AB}, and the weight of the first body 100 can be F_{CD}. When S_{AB}×F_{AB}=S_{CD}×F_{CD}, the rotation angle of the second body 200 relative to the first body 100 can be the maximal angle. Then, the electronic device can remain stable, and the linkage control assembly 300 can lock the second body 200 by limiting the position-limiting cooperation between the position-limiting linkage member 301 and the position-limiting cooperation member 302. Thus, the user can be prevented from opening the second body 200 to exceed the angle to remain the electronic device stable.

The telescopic length sensor can be a distance sensor that measures a distance between the telescopic end and the fixed end of the second body 200, a displacement sensor directly measures a telescopic amount of the telescopic end of the second body 200, and a telescopic motor configured to directly drive the second body 200 to extend and retract. The telescopic amount of the second body 200 can be sensed through the rotation time and/or the rotation angle of the telescopic motor. When the second body 200 is a scroll screen, the telescopic length sensor can reuse the scroll shaft driver. The telescopic length of the second body 200 can be calculated through a scroll angle of the scroll driver. Thus, as long as the element can sense the telescopic length of the second body 200, the element can be within the scope of the present disclosure.

To control the rotation angle of the position-limiting linkage member 301, the electronic device can directly control the rotation angle and/or the rotation time of the linkage rotation driver through the position-limiting linkage controller. For example, in some embodiments, the linkage rotation driver can be a linkage rotation motor. The rotation angle of the position-limiting linkage member 301 can be controlled by controlling the rotation angle and/or the rotation time of the linkage rotation motor. Thus, the rotation angle of the position-limiting linkage member 301 can adapt to the telescopic length of the second body 200. In addition, the electronic device can further include another rotation angle sensor. The rotation angle of the position-limiting linkage member 301 can be monitored according to the rotation angle sensor. When the position-limiting linkage member 301 is rotated to the rotation angle where the position-limiting linkage member 301 is adapted to the telescopic length of the second body 200. The position-limiting linkage controller can control the linkage rotation driver to stop running. Thus, the position-limiting linkage member 301 can stop rotating and can remain at the rotation angle where the position-limiting linkage member 301 is adapted to the telescopic length of the second body 200.

The second body 200 of the present disclosure can include a flexible screen. The first body 100 can include a scroll driver. The scroll driver can be configured to scroll the flexible screen to cause the flexible screen to scroll or be unfolded to realize the extension and retraction of the flexible screen. Based on the extension of the flexible screen, the weight of the flexible screen can be increased (i.e., F_{AB} is increased), and the weight of the first body 100 can be decreased (i.e., F_{CD} is decreased). The vertical projection length of the first body 100 on the carrier surface can be unchanged (i.e., S_{CD} is unchanged). When S_{AB}×F_{AB}=S_{CD}×F_{CD}, the linkage control assembly 300 can perform position-limiting on the rotation angle of the flexible screen through the position-limiting cooperation between the position-limiting linkage member 301 and the position-limiting mating member 302. Thus, the maximal rotation angle of the flexible screen relative to the first body 100 can be reduced. The vertical projection length of the flexible screen when the flexible screen is at the maximal rotation angle can be reduced (i.e., S_{AB} is decreased). The user cannot open the electronic device exceeding the rotation angle of the flexible screen relative to the first body 100, Thus, the electronic device can remain stable.

In some embodiments, the telescopic length sensor can reuse the scroll driver. The telescopic length of the flexible screen can be sensed through the scroll angle and/or the scroll length of the scroll driver. Thus, the scroll driver can move together with the position-limiting linkage member 301. An additional telescopic sensor may not needed. Thus, the number of components can be reduced, the cost can be reduced, and the electronic device can be light-weighted.

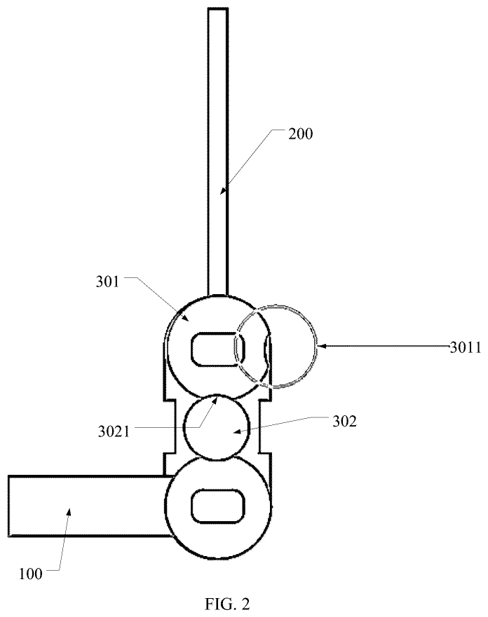

As shown in FIG. 2 and FIG. 3, the position-limiting linkage structure 3011 is arranged at the position-limiting linkage member 301. The positioning structure 3021 is arranged at the position-limiting cooperation member 302. Thus, when rotating along the first direction based on the extension length and/or the increased weight value of the second body 200, the position-limiting structure 3011 of the position-limiting linkage member 301 can rotate along the first direction. Thus, when the position-limiting structure 3011 and the positioning structure 3021 are in the position-limiting cooperation state, the rotation angle of the second body 200 can be reduced. That is, the maximal opening angle of the electronic device can be reduced. When rotating along the second direction based on the retracted length and/or the weight reduction value, the position-limiting structure 3011 of the position-limiting linkage member 301 can rotate along the second direction, i.e., along a reverse direction of the first direction. Thus, when the position-limiting structure 3011 and the positioning structure 3021 are in the position-limiting cooperation state, the rotation angle of the second body 200 can be increased. That is, the maximal opening angles of the electronic device can be increased, and the rotation angle of the second body 200 can be expanded.

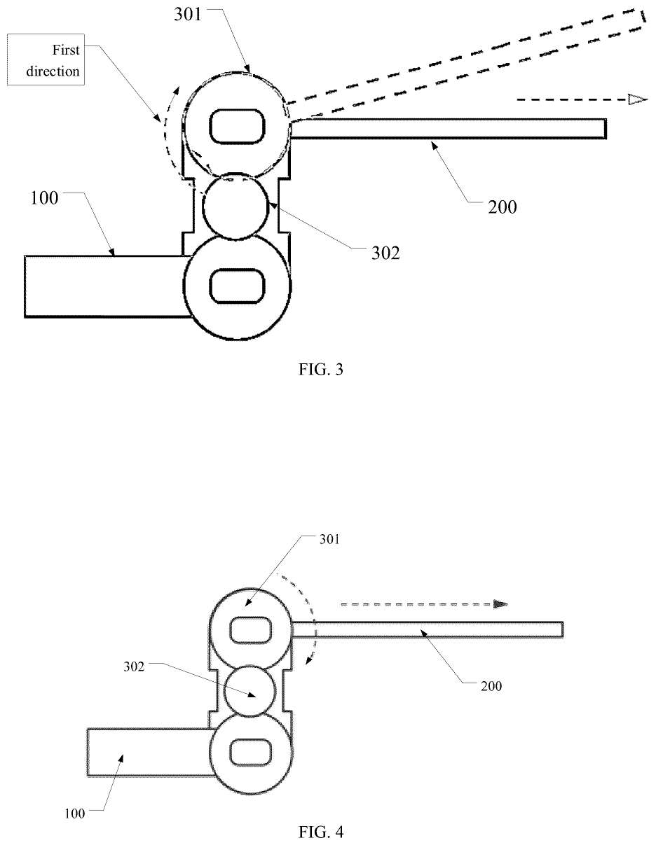

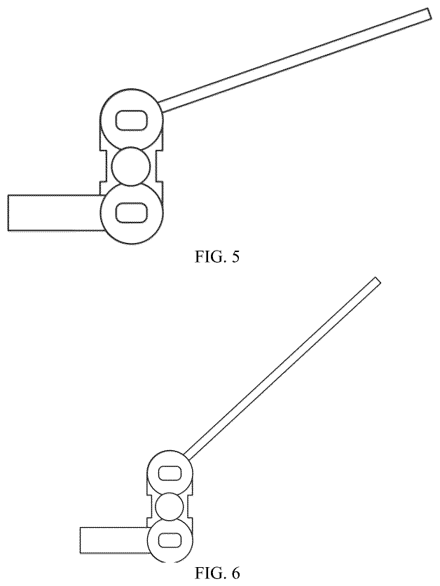

As shown in FIG. 4, when the second body 200 is at the first telescopic length, the maximal rotation angle of the second body 200 is 180°. That is, the maximal opening angle of the electronic device is 180°. The second body 200 can extend from the first telescopic length to the second telescopic length shown in FIG. 5, and the position-limiting linkage member 301 can rotate along the first direction (in embodiments of the present disclosure, the first direction can be in a clockwise direction, and the second direction can be a counterclockwise direction). The position-limiting structure 3011 can also rotate along the first direction. When the position-limiting structure 3011 and the positioning structure 3021 are in the position-limiting cooperation state, the maximal rotation angle of the second body 200 can be reduced to 160° shown in FIG. 5. The second body 200 can continue to extend to the third telescopic length, the position-limiting linkage member 301 can continue to rotate along the first direction, and the position-limiting structure 3011 can continue to rotate along the first direction. When the position-limiting structure 3011 and the positioning structure 3021 are in the position-limiting cooperation state, the maximal rotation angle of the second body 200 can be reduced to 120° shown in FIG. 6. The third telescopic length is greater than the second telescopic length, which is greater than the first telescopic length.

The structures of the position-limiting structure 3011 and the positioning structure 3021 are not limited in the present disclosure, as long as the structure can limit the rotatable position of the second body 200, which is within the scope of the present disclosure.

In some embodiments, one of the position-limiting structure 3011 and the positioning structure 3021 can be a concave member, and the other one can be a convex member. Position can be limited through the cooperation between the concave member and the convex member. In embodiments of the present disclosure, one of the position-limiting structure 3011 and the positioning structure 3021 can be a magnetic absorb member, and the other one can be an absorbed member. The position can be limited through the magnetic absorption between the magnetic absorb member and the absorbed member. In some other embodiments of the present disclosure, the position-limiting structure 3011 and the positioning structure 3021 can be a first friction piece and a second friction piece, respectively. The position can be limited through the friction force between the first friction piece and the second friction piece. In some other embodiments, the position-limiting structure 3011 can be a first connection structure, and the positioning structure 3021 can be the second connection structure. The position-limiting linkage control assembly 300 can further include an elastic element. Two ends of the elastic element can be connected to the first connection structure and the second connection structure, respectively. Thus, damping can be provided through the deformation force of the elastic element to limit the position. When the position-limiting linkage member 301 is rotated to the predetermined angle, the elastic element can be pulled or compressed to the limits, and the user cannot continue to rotate the second body 200. Thus, the position limiting can be realized for the rotation angle of the second body 200.

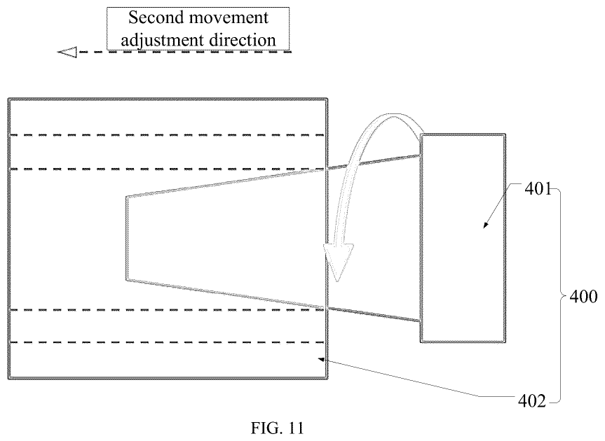

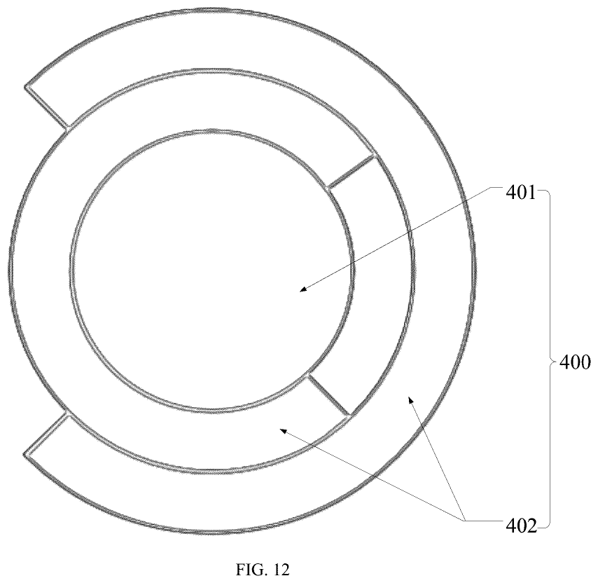

As shown in FIG. 11 and FIG. 12, the electronic device of the present disclosure also includes a damping adjustment mechanism. The damping adjustment mechanism includes a rotation angle detector, a damping linkage controller, and a first damper 400. The rotation angle detector can be configured to detect the rotation angle of the second body 200. The first damping assembly 400 can be configured to increase the rotation damping of the second body 200. The first damping assembly 400 and the rotation angle detector can send signals to the damping linkage controller. Thus, the rotation angle of the second body 200 can be detected through the rotation angle detector. The rotation angle of the second body 200 can be converted into the electrical signal to be transferred to the damping linkage controller. When the rotation angle detector detects that the rotation angle for the second body 200 is in the predetermined closed angle range, the damping linkage controller can control the first damping assembly 400 to increase the rotation damping. Thus, during the process of closing the electronic device, the rotation damping of the second body 200 can be increased when closing the electronic device to reduce rigid collision between the second body 200 and the first body 100 to protect the electronic device.

specific range values of the predetermined closed angle range of the present disclosure are not limited. In practical applications, the predetermined closed angle range can be adaptively adjusted according to actual needs. In some embodiments, as shown in FIG. 10, when the second body 200 of the present disclosure is closed to 40°-50°, the damping linkage controller begins to control the first damping assembly 400 to increase the rotation damping. Thus, the rigid collision between the second body 200 and the first body 100 can be reduced to protect the electronic device.

For the first damping assembly 400 of the present disclosure, the rotation damping can be increased by increasing the rotation friction of the rotation shaft of the second body 200 when the second body 200 is closed. In some other embodiments, an additional torque spring can be provided. The rotation damping when the second body 200 is closed can be increased by increasing the torque of the torque spring. As long as the setting method can satisfy the application requirement, the setting method can be within the scope of the present disclosure.

In some embodiments, the first damping assembly 400 can include a damping adjustment member 401, an elastic damper 402, and a damping driver. A friction chamber is arranged in the rotation shaft. The damping adjustment member 401 can be arranged in the friction chamber. The elastic damper 402 can be arranged between the damping adjustment member 401 and the inner wall of the friction chamber. An area of the cross-section of the damping adjustment member 401 can be gradually increased along the first movement adjustment direction. The first movement adjustment direction can be in a direction from inside of the friction chamber to the outside of the friction chamber parallel to the axis of the rotation shaft. Thus, the damping adjustment member 401 can move along the direction parallel to the axis of the rotation shaft to cause the pressure of the damping adjustment member 401 to the elastic damper 402 and the inner wall of the friction chamber to be increased. The damping driver can be configured to drive the damping adjustment member 401 to move along the direction parallel to the axis of the rotation shaft. The damping driver can be connected to the damping linkage controller through signals. When the rotation angle of the second body 200 is in the predetermined closed angle range, the damping linkage controller can control the damping driver to cause the damping adjustment member 401 to move along the second movement adjustment direction to increase the pressure between the elastic damper 402 and the inner wall of the friction chamber. Thus, the friction resistance can be increased, and the rigid collision between the first body 100 and the second body 200 when the second body 200 is closed can be reduced to protect the electronic device.

The elastic damper 402 can be an elastic rubber sleeve or an open-loop metal ring. As long as the elastic element can elastically deform along the radial direction of the friction chamber, the elastic element can be within the scope of the present disclosure. In some embodiments, as shown in FIG. 12, in some embodiments, the elastic damper 402 includes a plurality of annular open loop members. When the damping driver drives the damping adjustment member 401 to move along the second movement adjustment direction, the pressure of the damping adjustment member 401 for the annular open loop member can be increased. Thus, the annular open loop member can be slightly opened. When the damping driver drives the damping adjustment member 401 to move along the first movement adjustment direction, the pressure of the damping adjustment member 401 to the annular open loop member can be reduced. Thus, the annular open loop member can be restored based on the elastic force of the annular open loop member.

Furthermore, the first damping assembly 400 can further include a weight sensor arranged at the second body 200. The weight sensor can be configured to sense the weight of the second body 200. The weight sensor and the damping linkage controller can transmit signals to each other to cause the damping linkage controller to control the movement distance of the damping adjustment member 401 according to the weight of the second body 200. Thus, the first damping assembly 400 can dynamically control the movement distance of the damping adjustment member 401 according to the different weights of the second body 200. Therefore, the rotation damping of the second body 200 can be dynamically adjusted according to the weight of the second body 200.

In addition, in the electronic device of the present disclosure, the damping adjustment mechanism can include a second damping assembly. The second damping assembly can be configured to provide the fixed rotation damping to the second body 200 to improve the operability of the user opening and closing the second body 200.

The terms “first” and “second” in the present disclosure, appended claims, and the accompanying drawings are used to distinguish different objects and not to describe a specific order. Additionally, the terms “including,” “containing,” and any variations thereof are intended to encompass non-exclusive inclusion. For example, processes, methods, systems, products, or devices including a series of steps or units are not limited to those listed steps or units, but may include steps or units not listed.

The description of embodiments of the present disclosure can enable those skilled in the art to implement or use the present disclosure. Various modifications to embodiments of the present disclosure can be apparent to those skilled in the art. The general principle defined in the specification can be implemented in other embodiments without departing from the spirit or scope of the present disclosure. Thus, the present disclosure may not be limited to embodiments described in the specification but conform to the widest range consistent with the principle and novel features of the present disclosure.

What is claimed is:

1. An electronic device comprising:
a first body;
a second body;
a linkage control assembly including:
a rotation shaft configured to rotatably connect the first body and the second body;
a position-limiting linkage member arranged at the rotation shaft; and
a position-limiting mating member arranged at a side of the rotation shaft close to the first body, the position-limiting linkage member being configured to cooperate with the position-limiting mating member to perform position-limiting on the rotation angle of the second body;
wherein:
the position-limiting linkage member rotates based on an extension length and/or a weight increase value along a first direction;
the position-limiting linkage member rotates along a second direction based on the retraction length of the second body and/or a weight decrease value;
the first direction and the second direction are opposite directions.

2. The device according to claim 1, wherein:
the linkage control assembly further includes a linkage member configured to transmit a telescopic movement of the second body to the position-limiting linkage member in a mechanical transmission method;
wherein:
an end of the linkage member is arranged at a retraction end of the second body;
the other end cooperates with or is connected to the position-limiting linkage member to transmit the retractable movement of the second body to transmit the retractable movement of the second body to the position-limiting linkage member in the mechanical transmission method.

3. The device according to claim 2, wherein:
the linkage member includes a gear member, a transmission gear is arranged at an outer circumference of the position-limiting linkage member, and the transmission gear meshes with the gear member; or
the linkage member includes a linkage rod, and two ends of the linkage rod are rotatably connected to a retraction end of the second body and the position-limiting linkage member, respectively.

4. The device according to claim 1, wherein the linkage control assembly further includes:
a telescopic length sensor configured to sense a telescopic length of the second body;
a position-limiting linkage controller configured to transmit a signal to the telescopic length sensor; and
a linkage rotation driver configured to control the position-limiting linkage member to rotate, the linkage rotation driver transmitting a signal to the position-limiting linkage controller to cause the linkage rotation driver to control the rotation angle of the position-limiting linkage member according to the telescopic length of the second body.

5. The device according to claim 4, wherein:
the second body includes a flexible screen, the first body includes a scroll driver configured to scroll a flexible screen; and
the telescopic length sensor reuses a scroll driver to enable mutual linkage between the scroll driver and the position-limiting linkage piece.

6. The device according to claim 1, wherein:
a position-limiting structure is arranged at the position-limiting linkage member, and a positioning structure is arranged a the position-limiting mating member;
one of the position-limiting structure and the positioning structure is a concave member, and the other is a convex member, and position is limited through a cooperation between the concave member and the convex member;
one of the position-limiting structure and the positioning structure is a magnetic absorber, and the other one is an absorbed member, and the position is limited through a magnetic absorption between the magnetic absorber and the absorbed member;
the position-limiting structure and the position structure are a first friction piece and a second friction piece, respectively, and the position is limited through the friction between the first friction piece and the second friction piece; or
the position-limiting structure bis a first connection structure, the positioning structure is a second connection structure, the position-limiting linkage control assembly further includes an elastic element, two ends of the elastic element are connected to the first connection structure and the second connection structure, respectively, and damping is provided through a deformation force of the elastic element to limit the position.

7. The device according to claim 1, further comprising a damping adjustment mechanism including:
a rotation angle detector configured to detect a rotation angle of the second body;
a damping linkage controller; and
a first damping assembly configured to increase rotation damping of the second body;
wherein:
the first damping assembly and the rotation angle detector transmit a signal to the damping linkage controller, when the rotation angle detector detecting that the rotation angle of the second body is in a predetermined closed angle range, the damping linkage controller controls the first damping assembly to increase rotation damping.

8. The device according to claim 7, wherein the first damping assembly includes:
a damping adjustment member, the rotation shaft includes a friction chamber configured to accommodate the damping adjustment member, an area of a cross-section of the damping adjustment member gradually increasing along a first movement adjustment direction, and the first movement adjustment direction being a direction from inside of the friction chamber to outside of the friction chamber and parallel to the axis of the rotation shaft;
an elastic damper arranged between the damping adjustment member and an inner wall of the friction chamber; and
a damping driver configured to drive the damping adjustment member to move along a direction parallel to an axis of the rotation shaft, and the damping driver and the damping linkage controller are connected to each other through signals;
wherein:
when the rotation angle of the second body is in the predetermined closed angle range, the damping linkage controller controls the damping driver to cause the damping adjustment member to move along a second movement adjustment direction, and the second movement adjustment direction is a direction opposite to the first movement adjustment direction to increase pressure between the elastic damper and the inner wall of the friction chamber to increase friction resistance.

9. The device according to claim 8, wherein:
the first damping assembly further includes a weight sensor arranged at the second body;
the weight sensor is configured to sense the weight of the second body; and
the weight sensor and the damping linkage controller send signals to each other to cause the damping linkage controller to control the movement distance of the damping adjustment member according to the weight of the second body.

10. The device according to claim 7, wherein the damping adjustment mechanism further includes a second damping assembly configured to provide fixed rotation damping for the second body.
